(19) United States
(12) Patent Application Publication
(10) Pub. No.: US 2026/0290739 A1
(43) Pub. Date: Sep. 24, 2026

(54) X-RAY TUBES, ENCLOSURES FOR X-RAY TUBES, AND METHODS OF MANUFACTURE

(71) Applicant: VAREX IMAGING CORPORATION, Salt Lake City, UT (US)

(72) Inventors: Thomas Anton Morris, Spanish Fork, UT (US); Jonathan Miller, Murray, UT (US)

(73) Assignee: VAREX IMAGING CORPORATION, Salt Lake City, UT (US)

(21) Appl. No.: 19/083,848

(22) Filed: Mar. 19, 2025

(51) Int. Cl. H01J 35/18; H01J 9/26; H01J 35/06

(52) U.S. Cl. CPC H01J 35/18; H01J 9/265; H01J 35/064

(57) ABSTRACT

Enclosures for X-ray tubes, X-ray tubes including the enclosures, and methods of manufacturing enclosures and X-ray tubes are disclosed. An X-ray tube can include a cathode, an anode, and an enclosure at least partially surrounding the cathode and the anode. The enclosure can include an aluminum alloy that at least partially defines an evacuated enclosure of the X-ray tube.

### FIELD

The described embodiments relate generally to enclosures for X-ray tubes. More particularly, the described embodiments relate to materials for enclosures having reduced weight and improved manufacturability, configurations for enclosures, and methods of manufacturing enclosures.

### BACKGROUND

X-ray tubes can be used in a wide variety of applications, both industrial and medical, to produce X-rays. An X-ray tube typically includes a cathode, and an anode positioned within an evacuated enclosure (also referred to as a tube, a body, an insert, or a housing). The cathode includes an electron source, and the anode includes a target surface that is oriented to receive electrons emitted by the electron source. During operation of the X-ray tube, an electric current is applied to the electron source, which causes electrons to be produced. The electrons are accelerated toward the target surface of the anode by applying a high-voltage potential between the cathode and the anode. When the electrons strike the anode target surface, the kinetic energy of the electrons causes the production of X-rays. Multi-beam X-ray tubes can include a plurality of cathode assemblies and anodes, which produce X-rays at a plurality of focal spots. The X-ray tube can include a window through which a portion of the X-rays exits the X-ray tube. The X-rays that exit the X-ray tube can then interact with a material sample, a patient, or another object.

### SUMMARY

An aspect of the present disclosure relates to an X-ray tube including a cathode, an anode, and an enclosure at least partially surrounding the cathode and the anode. The enclosure can include an aluminum alloy at least partially defining an evacuated enclosure of the X-ray tube.

In one or all examples, the cathode can be one of a plurality of cold cathode emitters disposed at least partially in the enclosure. In one or all examples, the aluminum alloy of the enclosure defines an X-ray window.

In one or all examples, the aluminum alloy of the enclosure can include a single continuous material defining a plurality of side surfaces of the evacuated enclosure. In one or all examples, the single continuous material of the aluminum alloy of the enclosure can define at least five side surfaces of the evacuated enclosure. The enclosure can further include an aluminum alloy lid welded to the single continuous material. In one or all examples, the single continuous material of the aluminum alloy of the enclosure can define at least four side surfaces of the evacuated enclosure. The enclosure can further include two aluminum alloy end caps welded to the single continuous material.

In one or all examples, the enclosure can have an octagonal cross-sectional shape. In one or all examples, the enclosure can have a rounded cross-sectional shape. In one or all examples, the enclosure and an X-ray window defined in the enclosure can have curved shapes in a cross-sectional view.

Another aspect of the present disclosure relates to a method of manufacturing an enclosure for an X-ray tube, the method including forming an enclosure body from an aluminum alloy, machining an X-ray window in the enclosure body, welding a wall to the enclosure body to form an enclosure, and evacuating the enclosure at least partially defined by the enclosure body and the wall.

In one or all examples, the enclosure body can be formed by billet machining. In one or all examples, the billet machining can define side surfaces and a bottom surface of the enclosure body that define at least five surfaces of the enclosure.

In one or all examples, the enclosure body can be formed by extrusion. In one or all examples, the extrusion can define side surfaces of the enclosure body that define at least four surfaces of the enclosure.

In one or all examples, the method can further include anodizing an inner surface of the enclosure body. In one or all examples, the method can further include mounting a cathode assembly to the enclosure body, mounting an anode assembly to the enclosure body, and performing a bake-out process on the enclosure at a temperature of 250° C. or less after mounting the cathode assembly and the anode assembly.

In yet another aspect of the present disclosure, an X-ray source includes an insert including a plurality of surfaces defining an evacuated enclosure. A material defining the plurality of surfaces can be formed from aluminum or an aluminum alloy including at least 1 weight percent aluminum.

In one or all examples, the X-ray source can further include a plurality of cold cathode emitters coupled to the enclosure. The X-ray source can be configured to produce a plurality of X-ray beams.

In one or all examples, the material defining the plurality of surfaces can include 5000 or 6000 series aluminum. In one or all examples, the material can include a single continuous material defining at least four surfaces of the plurality of surfaces.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A is a top-down view of an X-ray tube including an enclosure with a square cross-section.

FIG. 1B is a side view of the X-ray tube of FIG. 1A.

FIG. 1C is a front-to-back view of the X-ray tube of FIG. 1A.

FIG. 2A is a top-down view of an X-ray tube including an enclosure with an octagonal cross-section.

FIG. 2B is a side view of the X-ray tube of FIG. 2A.

FIG. 2C is a front-to-back view of the X-ray tube of FIG. 2A.

FIG. 3A is a top-down view of an X-ray tube including a top-loaded enclosure.

FIG. 3B is a side view of the X-ray tube of FIG. 3A.

FIG. 3C is a front-to-back view of the X-ray tube of FIG. 3A.

FIG. 4A is a top-down view of an X-ray tube including an enclosure with a round cross-section.

FIG. 4B is a front-to-back view of the X-ray tube of FIG. 4A.

FIG. 4C is a side view of the X-ray tube of FIG. 4A.

FIG. 5A is a top-down view of a curved X-ray tube.

FIG. 5B is a sectional view of the X-ray tube of FIG. 5A.

FIG. 5C is a bottom-up view of the X-ray tube of FIG. 5A.

FIG. 6A is a top-down view of an X-ray tube including a front-loaded enclosure.

FIG. 6B is a side view of the X-ray tube of FIG. 6A.

FIG. 6C is a front-to-back view of the X-ray tube of FIG. 6A.

FIG. 7A is a top-down view of an X-ray tube including electronics mounted to an enclosure.

FIG. 7B is a side view of the X-ray tube of FIG. 7A.

FIG. 7C is a side view of the X-ray tube of FIG. 7A.

FIG. 8A is an exploded view of an X-ray tube including a shield.

FIG. 8B is a perspective view of the X-ray tube of FIG. 8A.

FIG. 8C is a cross-sectional view of the X-ray tube of FIG. 8A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to X-ray tubes, which can be used to generate X-rays. Representative applications for X-ray tubes include, but are not limited to, imaging, medicine, diagnostics, radiology, radiotherapy, radiography and tomography, and a range of industrial X-ray technologies. More specifically, the following disclosure relates to materials, manufacturing processes, and configurations for enclosures for X-ray tubes. The enclosures can at least partially define evacuated enclosures of the X-ray tubes, and utilizing the disclosed materials, manufacturing processes, and configurations to form the enclosures can reduce the cost and weight of the enclosures, while improving performance of the enclosures.

X-ray tubes generally include a cathode and an anode positioned within an enclosure, which may define an evacuated enclosure. A high voltage power source can be connected across the cathode and the anode such that electrons are emitted from the cathode towards the anode. A target surface can be defined on the anode and X-rays can be generated as the electrons impact the target surface. Conventionally, enclosures can be formed from stainless steel. Stainless steel can provide certain advantages, such as being able to operate X-ray tubes at high temperatures. However, stainless steel can also be associated with a number of disadvantages, such as high weight, high cost, complex manufacturing processes, high outgassing, and the like.

The following disclosure relates to X-ray tube enclosures formed from aluminum, X-ray tubes including the enclosures, and manufacturing methods for the enclosures and X-ray tubes. By using aluminum as a material for enclosures, the enclosures can be formed with reduced weight, reduced outgassing, reduced cost, reduced manufacturing time, improved performance, and the like.

In one or all examples, the X-ray tubes of the present disclosure can be multi-beam X-ray tubes that include liquid cooled anode assemblies and cold cathode emitters. Heat can be generated throughout an X-ray tube. For example, in a conventional X-ray tube, cathodes can be operated at high temperatures and heat can be generated at the anode due to electrons striking the anode. Cold cathode emitters can operate at relatively low temperatures. Providing liquid cooling to the anode assembly can also reduce the operating temperature of an X-ray tube. Thus, by providing X-ray tubes that include cold cathode emitters and liquid cooled anode assemblies, operating temperatures of the X-ray tubes can be reduced. This allows for a greater variety of materials to be used for components of the X-ray tubes, such as the enclosure of the X-ray tube. Specifically, conventional X-ray tubes can often use stainless steel for the enclosure, as this material has a high melting temperature and is resistant to deformation and the like at the elevated temperatures of a conventional X-ray tube. By reducing the operating temperature of X-ray tubes of the present disclosure, materials such as aluminum, that have lower melting temperatures and can suffer deformation at lower temperatures, can be used. Aluminum can have reduced weight, reduced cost, easier manufacturability, and other benefits relative to stainless steel.

In one or all examples, an enclosure can be formed by extruding a body portion and welding two end caps to the body portion. The body portion can have a square, rectangular, octagonal, round, circular, or other desired cross-sectional shape and the end caps can have complementary shapes. The enclosure can define an evacuated enclosure, such as by each of the end caps defining a surface of the evacuated enclosure and the body portion defining four or more surfaces of the evacuated enclosure. In one or all examples, an enclosure can be formed by billet machining a body portion and welding a lid to the body portion. The enclosure can define an evacuated enclosure, such as by the lid defining a surface of the evacuated enclosure and the body portion defining five or more surfaces of the evacuated enclosure. An X-ray window can be defined in the body portion of the enclosures, and various components of the X-ray tube can be mounted to the enclosures.

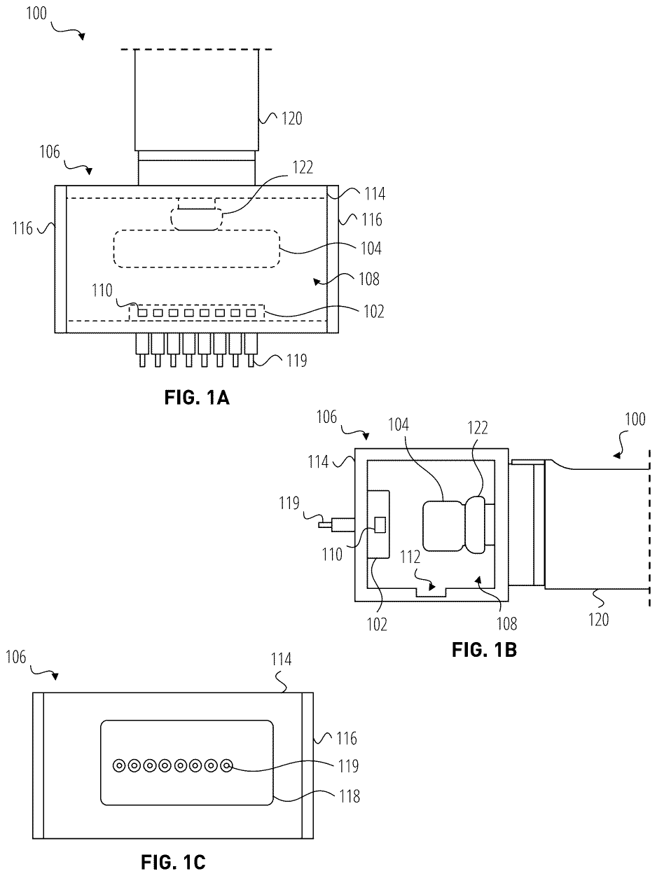

These and other examples are discussed below with reference to FIG. 1A through FIG. 7C. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A through 1C illustrate various views of an X-ray tube 100. FIG. 1A is a top-down view, FIG. 1B is a side view, and FIG. 1C is a front-to-back view. The X-ray tube 100 can be used to generate X-rays. For example, the X-ray tube 100 can include a cathode assembly 102 and an anode assembly 104 positioned within an enclosure 106. In other words, the enclosure 106 can at least partially surround the cathode assembly 102 and the anode assembly 104. The enclosure 106 can define an evacuated enclosure 108, which can maintain an ultra-high vacuum (UHV). A high voltage can be applied between the cathode assembly 102 and the anode assembly 104 such that electrons are emitted from individual cathodes 110 of the cathode assembly 102 towards target surfaces on the anode assembly 104. X-rays can be generated as the electrons impact the target surfaces on the anode assembly 104 and the X-rays can be emitted from the X-ray tube 100 through an X-ray window 112. The X-ray window 112 can be defined in the enclosure 106.

The X-ray tube 100 is an example of a multi-beam X-ray tube, which can include a plurality of cathodes 110. Each of the cathodes 110 can generate an electron beam, which can be directed towards a focal spot on the anode assembly 104. The cathodes 110 can be, in some or all examples, cold cathode emitters. The anode assembly 104 can be a liquid cooled anode assembly. Using cold cathode emitters and a liquid cooled anode assembly in the X-ray tube 100 can allow the X-ray tube 100 to operate at a reduced operating temperature, such as an operating temperature of less than about 350° C., less than about 300° C., less than about 250° C., less than about 200° C., or the like. This can provide greater flexibility in the materials and processes that can be used to form the X-ray tube 100, such as allowing the enclosure 106 to be formed from aluminum-based materials. Further, because multi-beam X-ray tubes have relatively large sizes (e.g., as compared to single-beam X-ray tubes), cost and weight can be particularly important in multi-beam X-ray tubes. Using aluminum-based materials for the enclosure 106 can reduce the weight and cost of the X-ray tube 100. Although the X-ray tube 100 is described in the context of a multi-beam X-ray tube, the methods, materials, and teachings of the present disclosure can also be used in single-emitter, single-beam X-ray tubes and the like.

The enclosure 106 can include a body portion 114 and two end caps 116. The body portion 114 and the end caps 116 can each be formed from aluminum-based materials, such as aluminum, an aluminum alloy, or the like. For example, the body portion 114 and the end caps 116 can be formed from any aluminum alloy series including, but in no way limited to a 5000 series, a 6000 series (e.g., 6061-T6 or other 6000 series), or a 7000 series aluminum alloy. An aluminum concentration in each of the body portion 114 and the end caps 116 may be at least about 1 weight percent (wt. %), at least about 3 wt. %, at least about 10 wt. %, at least about 90 wt. %, at least about 95 wt. %, at least about 97wt. %, or the like. Although the enclosure 106 is described as being formed from aluminum or an aluminum-based materials, in one or all examples, the enclosure 106 can be formed from other metals, such as steel (e.g., stainless steel), copper, titanium, tungsten, lead, combinations or alloys thereof, or the like.

The body portion 114 can have a rectangular shape in a top-down view (e.g., FIG. 1A) and a front-to-back view (e.g., FIG. 1C). The body portion 114 can have a square shape or rectangular shape in a cross-sectional or side view (e.g., FIG. 1B), and an opening in the body portion 114 that houses components of the X-ray tube 100 can have a square or rectangular shape in the cross-sectional or side view. The body portion 114 can have a constant thickness, except in portions of the body portion 114 that are machined to house or define components of the X-ray tube 100, such as the cathode assembly 102, the anode assembly 104, the X-ray window 112, and the like. The end caps 116 can have shapes that complement the cross-sectional shape of the body portion 114. For example, the end caps 116 can have square or rectangular shapes in the side view illustrated in FIG. 1B. In other words, the end caps 116 can have the same outlines or boundaries as the body portion 114 in the side view. The body portion 114 and the end caps 116 can have any suitable thickness, which can be dependent on the application for the X-ray tube 100.

The body portion 114 can be formed, in some or all examples, by a near-net process, such as extrusion. As such, minimal additional manufacturing steps are performed on the body portion 114. This can, for example, reduce waste, manufacturing steps for forming the body portion 114, cost, and manufacturing time for the body portion 114. In one or all examples, the body portion 114 can be formed by billet machining, casting, other aluminum machining processes, or the like. Forming the body portion 114 by extrusion, billet machining, casting, or the like can be used to form the body portion 114 as a single or unitary component formed from a single, continuous material, which can reduce or eliminate welds, seams, or other interfaces in the enclosure 106. This can reduce assembly steps, assembly complexity, and leak points in the enclosure 106.

An X-ray window 112 can be defined in the body portion 114 by machining processes (e.g., milling, turning, drilling, boring, reaming, plasma cutting, laser machining, water jet machining, or the like). In one or all examples, x-ray filtration requirements can differ from the x-ray filtration provided by the X-ray window 112 in the body portion 114. In such examples, additional window materials can be brazed, welded, bolted, or otherwise fastened to an inner or outer surface of the body portion 114. In one or all examples, a collimator can be brazed, welded, bolted, or otherwise fastened to an inner or outer surface of the body portion 114. The end caps 116 can be formed from aluminum sheets or plates. Each of the end caps 116 can be welded to the body portion 114. The enclosure 106 can have a limited number of welds, which reduces assembly steps, assembly complexity, and leak points in the enclosure 106. The enclosure 106 can include the body portion 114 and the two end caps 116, which can reduce a part count, assembly steps, assembly time, and assembly complexity for the enclosure 106.

Aluminum has a relatively high heat conductivity such that forming the X-ray window 112, which is subject to heating due to bombardment from X-rays, can improve heat dissipation by the X-ray window 112. Moreover, forming the X-ray window 112 from a material that is continuous with the body portion 114 further improves heat dissipation from the X-ray window 112 to the body portion 114.

The evacuated enclosure 108 of the X-ray tube 100 can be defined by the enclosure 106. For example, the end caps 116 can define two side surfaces of the evacuated enclosure 108, the body portion 114 can define two side surfaces of the evacuated enclosure 108, the body portion 114 can define a top surface of the evacuated enclosure 108, and the body portion 114 can define a bottom surface of the evacuated enclosure 108. In other words, the end caps 116 can define two surfaces of the evacuated enclosure 108 and the body portion 114 can define four surfaces of the evacuated enclosure 108.

By forming the body portion 114 and the end caps 116 from aluminum, a weight of the enclosure 106 and the X-ray tube 100, material costs, and manufacturing time, steps, and costs, can be reduced relative to traditional X-ray tubes. This can be particularly beneficial for multi-beam X-ray tubes, which have larger sizes and weights. Aluminum has less outgassing relative to stainless steel and other materials that can be used for X-ray tube enclosures, and the enclosure 106 can maintain an improved evacuated condition. Aluminum is a recyclable material and the components of the enclosure 106 can be recyclable. Further, as described above, the enclosure 106 can be formed from a limited number of components with a limited number of seams, welds, or interfaces, which further increases the recyclability of the enclosure 106.

The cathode assembly 102 can include a body portion 118 to which the cathodes 110 are coupled. Each of the cathodes 110 can include an electrical connection that passes from within the evacuated enclosure 108 to outside the evacuated enclosure by means of a vacuum feedthrough 119. The vacuum feedthroughs 119 can include a stainless steel ring coupled to a ceramic body. The body portion 118 can be formed from one or more metal materials and can be welded to the body portion 114. For example, the body portion 118 can include stainless steel and aluminum, which can be bonded to one another by any suitable direct metal-to-metal bonding technique (also referred to as dissimilar metal joining processes), such as diffusion bonding, explosion bonding, spin welding, ultrasonic welding, friction welding, other bi-material bonding methods, or the like. The stainless steel of the vacuum feedthroughs 119 can be coupled to the stainless steel of the body portion 118 by welding, brazing, or the like. The aluminum of the body portion 118 can be bonded to the body portion 114 by welding, brazing, or the like. Power can be supplied to portions of the cathodes 110 outside the evacuated enclosure 108 defined by the enclosure 106 (e.g., to the vacuum feedthroughs 119). The weld between the body portion 118 and the body portion 114 can achieve a reliable hermetic seal. Further, surfaces of the body portion 118 can at least partially define the evacuated enclosure 108 and the surfaces of the body portion 118 that define the evacuated enclosure 108 can be formed from aluminum. This helps to prevent any outgassing from the body portion 118 into the evacuated enclosure 108. The body portion 118 of the cathode assembly 102 can be coupled to the body portion 114 through an opening defined in a side surface of the body portion 114.

By including a cathode assembly 102 in the X-ray tube 100 that is welded to the enclosure 106, the cathode assembly 102 can be processed separately from other portions of the X-ray tube 100 and welded to the enclosure in a final sealing weld between the body portion 118 and the enclosure 106. This allows for processing of the cathode assembly 102 on a separate timeline from other components of the X-ray tube 100, until the cathode assembly 102 is coupled to the enclosure 106. This also allows for maintaining cleanliness of the cathode assembly 102 and sensitive cold cathode emitters (e.g., cathodes 110), limiting their exposure to atmosphere and/or contaminants. Cold cathode emitters benefit from low particle counts and low gas loads. As such, the cathode assembly 102 can be coupled to the X-ray tube 100 in a clean space, a clean room, or another controlled environment. Including a cathode assembly 102 that welds into or is otherwise coupled to and is separate from the enclosure 106 enables this improved, clean process.

The anode assembly 104 can be coupled to a cable 120 through a connector 122. The cable 120 can be a high-voltage cable and the connector 122 can be a high-voltage connector. The connector 122, via the cable 120, facilitates the provision of an electrical voltage bias to the anode assembly 104 during operation of the X-ray tube 100. The anode assembly 104 can also be mounted to the enclosure 106 through the connector 122, and the connection or coupling between the anode assembly 104 and the enclosure 106 through the connector 122 can at least partially control the spacing between the anode assembly 104 and the cathode assembly 102. The cable 120 and the connector 122 can be coupled to one another through an opening defined in a side surface of the body portion 114.

Various portions of the enclosure 106 can be machined with tight tolerances in order to control the thickness of the X-ray window 112 and the spacing between components (e.g., between the cathode assembly 102 and the anode assembly 104). Aluminum is relatively easy to machine; thus, forming the enclosure 106 from aluminum can reduce machining time and difficulty for machining the enclosure 106 and allow for tighter tolerances to be achieved in the X-ray tube 100, relative to traditional X-ray tubes. This can help to machine the X-ray window 112 to a very accurate thickness and control a spacing between the cathode assembly 102 and the anode assembly 104. As such, forming the enclosure 106 from aluminum provides improved control of the spacing between the cathode assembly 102 and the anode assembly 104 and positions of the cathode assembly 102 and the anode assembly 104 relative to the X-ray window 112 and these characteristics can be achieved with better repeatability between enclosures 106 and X-ray tubes 100. This reduces device defects and improves throughput for the X-ray tubes 100.

Various treatments can be performed on the X-ray tube 100 or components thereof during the manufacturing process of the X-ray tube 100. For example, surface treatments can be formed on the components of the enclosure 106. Surfaces of the body portion 114 and/or the end caps 116, including internal and/or external surfaces, can be anodized to change the color and/or texture of the surfaces. This can alter emissivity of the surfaces, can be used to alter heat transfer between the surfaces (e.g., through radiative heat transfer between surfaces), and can improve aesthetics of the X-ray tube 100. After the X-ray tube 100 is assembled, an out-gassing bake can be performed on the X-ray tube 100. Because aluminum has less out-gassing and higher degrees of cleanliness relative to materials such as stainless steel, this out-gassing bake can be performed at a reduced temperature, time, and cost relative to conventional processes. For example, the out-gassing bake can be performed at a temperature of up to about 200° C., up to about 250° C., or the like for a period of up to about 10 hours. Longer times can also be employed for further reduction of gas load. However, when compared to conventional materials for the enclosure 106, time periods for the out-gassing bake can be greatly reduced to achieve target cleanliness vacuum outgas at target pressures.

In one or all examples, additional components of the X-ray tube 100 can be attached to the enclosure 106. The additional components can include feed-throughs (e.g., electrical feed-throughs), tubes (e.g., vacuum or evacuation tubes), and the like. The additional components can include stainless steel components, copper components, or components formed from other suitable materials. The additional components can be attached or coupled to the enclosure 106 through brazing or other dissimilar metal joining processes. In some examples, the additional components can include transition components or the like. For example, a stainless steel component can include an aluminum transition component bonded to the stainless steel component by a dissimilar metal joining process. The aluminum transition component can be attached or coupled to the enclosure 106 through welding or brazing. Copper components can be directly brazed to the enclosure 106.

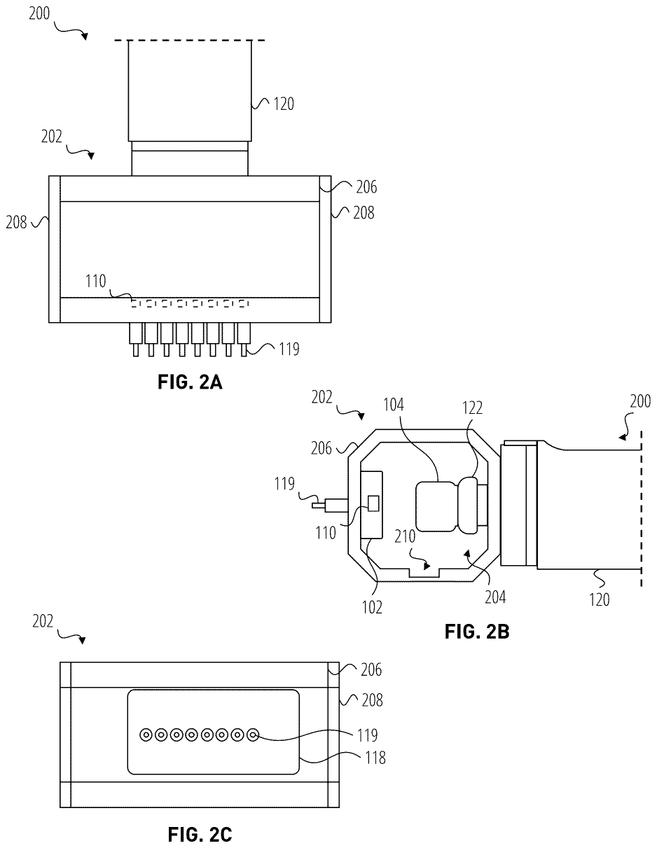

FIGS. 2A through 2C illustrate various views of an X-ray tube 200. FIG. 2A is a top-down view, FIG. 2B is a side view, and FIG. 2C is a front-to-back view. The X-ray tube 200 can be the same as or similar to the X-ray tube 100, except that an enclosure 202 of the X-ray tube 200 can have an octagonal shape in a cross-sectional or side view. Components of the X-ray tube 200 that are the same as or similar to components of the X-ray tube 100 are indicated with the same reference numbers as FIGS. 1A through 1C, and additional description of these components is omitted for simplicity.

The X-ray tube 200 can be used to generate X-rays. For example, the X-ray tube 200 can include a cathode assembly 102 and an anode assembly 104 positioned within an enclosure 202. The enclosure 202 can define an evacuated enclosure 204, which can maintain an ultra-high vacuum (UHV). A high voltage can be applied between the cathode assembly 102 and the anode assembly 104 such that electrons are emitted from individual cathodes 110 of the cathode assembly 102 towards target surfaces on the anode assembly 104. X-rays can be generated as the electrons impact the target surfaces on the anode assembly 104 and the X-rays can be emitted from the X-ray tube 200 through an X-ray window 210. The X-ray window 210 can be defined in the enclosure 202.

As discussed in reference to the X-ray tube 100, the enclosure 202 can be formed from aluminum-based materials. Using aluminum-based materials for the enclosure 202 can reduce the weight and cost of the X-ray tube 200. The enclosure 202 can include a body portion 206 and two end caps 208. The body portion 206 and the end caps 208 can each be formed from aluminum-based materials, such as aluminum, an aluminum alloy, or the like. For example, the body portion 206 and the end caps 208 can be formed from any series of aluminum alloys including, but in no way limited to, a 5000 series, a 6000 series, or a 7000 series aluminum alloy. An aluminum concentration in each of the body portion 206 and the end caps 208 may be at least about 1 weight percent (wt. %), at least about 3 wt. %, at least about 10 wt. %, at least about 90 wt. %, at least about 95 wt. %, at least about 97wt. %, or the like. Although the enclosure 202 is described as being formed from aluminum or an aluminum-based materials, in one or all examples, the enclosure 202 can be formed from other metals, such as steel (e.g., stainless steel), copper, titanium, tungsten, lead, combinations or alloys thereof, or the like.

The body portion 206 can have a rectangular shape in a top-down view (e.g., FIG. 2A) and a front-to-back view (e.g., FIG. 2C). The body portion 206 can have an octagonal or another polygonal shape in a cross-sectional or side view (e.g., FIG. 2B), and an opening in the body portion 206 that houses components of the X-ray tube 200 can have an octagonal or another polygonal shape in the cross-sectional or side view. The body portion 206 can have a constant thickness, except in portions of the body portion 206 that are machined to house or define components of the X-ray tube 200, such as the cathode assembly 102, the anode assembly 104, the X-ray window 210, and the like. The end caps 208 can have shapes that complement the cross-sectional shape of the body portion 206. For example, the end caps 208 can have octagonal or other polygonal shapes in the side view illustrated in FIG. 2B. In other words, the end caps 208 can have the same outlines or boundaries as the body portion 206 in the side view. The body portion 206 and the end caps 208 can have any suitable thickness, which can be dependent on the application for the X-ray tube 200.

The evacuated enclosure 204 of the X-ray tube 200 can be defined by the enclosure 202. For example, the end caps 208 can define two side surfaces of the evacuated enclosure 204, the body portion 206 can define six side surfaces of the evacuated enclosure 204, the body portion 206 can define a top surface of the evacuated enclosure 204, and the body portion 206 can define a bottom surface of the evacuated enclosure 204. In other words, the end caps 208 can define two surfaces of the evacuated enclosure 204 and the body portion 206 can define eight surfaces of the evacuated enclosure 204. The body portion 118 of the cathode assembly 102 can be coupled to the body portion 206 through an opening defined in a side surface of the body portion 206. The cable 120 and the connector 122 can be coupled to one another through an opening defined in a side surface of the body portion 206, and the anode assembly 104 can be coupled to the side surface of the body portion 206 through the connector 122.

By forming the enclosure 202 with an octagonal shape, wasted space can be eliminated from the enclosure 202. This can reduce a volume of the evacuated enclosure 204 defined by the enclosure 202 and reduce electrical standoff, which can increase performance of the X-ray tube 200. Further, weight of the enclosure 202 can be reduced. The octagonal shape of the enclosure 202 still provides flat surfaces for components of the X-ray tube 200 to be mounted to within the enclosure 202.

The body portion 206 can be formed by a near-net process, such as extrusion. As such, minimal additional manufacturing steps are performed on the body portion 206. This can, for example, reduce waste, manufacturing steps for forming the body portion 206, cost, and manufacturing time for the body portion 206. In one or all examples, the body portion 206 can be formed by billet machining, casting, other aluminum machining processes, or the like. Forming the body portion 206 by extrusion, billet machining, casting, or the like can be used to form the body portion 206 as a single or unitary component formed from a single, continuous material, which can reduce or eliminate welds, seams, or other interfaces in the enclosure 202. This can reduce assembly steps, assembly complexity, and leak points in the enclosure 202.

An X-ray window 210 can be defined in the body portion 206 by machining processes (e.g., milling, turning, drilling, boring, reaming, plasma cutting, laser machining, water jet machining, or the like). In one or all examples, x-ray filtration requirements can differ from the x-ray filtration provided by the X-ray window 210 in the body portion 206. In such examples, additional window materials can be brazed, welded, bolted, or otherwise fastened to an inner or outer surface of the body portion 206. In one or all examples, a collimator can be brazed, welded, bolted, or otherwise fastened to an inner or outer surface of the body portion 206. The end caps 208 can be formed from aluminum sheets or plates. Each of the end caps 208 can be welded to the body portion 206. The enclosure 202 can have a limited number of welds, which reduces assembly steps, assembly complexity, and leak points in the enclosure 202. The enclosure 202 can include the body portion 206 and the two end caps 208, which can reduce a part count, assembly steps, assembly time, and assembly complexity for the enclosure 202.

By forming the body portion 206 and the end caps 208 from aluminum, a weight of the enclosure 202 and the X-ray tube 200, material costs, and manufacturing time, steps, and costs, can be reduced. This can be particularly beneficial for multi-beam X-ray tubes, which have larger sizes and weights. Aluminum has less outgassing relative to stainless steel and other materials that can be used for X-ray tube enclosures, and the enclosure 202 can maintain an improved evacuated condition. Aluminum is a recyclable material and the components of the enclosure 202 can be recyclable. Further, as described above, the enclosure 202 can be formed from a limited number of components with a limited number of seams, welds, or interfaces, which further increases the recyclability of the enclosure 202.

Various portions of the enclosure 202 can be machined with tight tolerances in order to control the thickness of the X-ray window 210 and the spacing between components (e.g., between the cathode assembly 102 and the anode assembly 104). Aluminum is a material that is relatively easy to machine; thus, forming the enclosure 202 from aluminum can reduce machining time and difficulty for machining the enclosure 202 and allow for tighter tolerances to be achieved in the X-ray tube 200. This can help to machine the X-ray window 210 to a very accurate thickness and control a spacing between the cathode assembly 102 and the anode assembly 104. As such, forming the enclosure 202 from aluminum provides improved control of the spacing between the cathode assembly 102 and the anode assembly 104 and positions of the cathode assembly 102 and the anode assembly 104 relative to the X-ray window 210 and these characteristics can be achieved with better repeatability between enclosures 202 and X-ray tubes 200. This reduces device defects and improves throughput for the X-ray tubes 200. Further, various treatments can be performed on the X-ray tube 200, including surface treatments on surfaces of the enclosure 202, an out-gassing bake, and the like. Aluminum has a relatively high heat conductivity such that forming the X-ray window 210, which is subject to heating due to bombardment from X-rays, can improve heat dissipation by the X-ray window 210. Moreover, forming the X-ray window 210 from a material that is continuous with the body portion 206 further improves heat dissipation from the X-ray window 210 to the body portion 206.

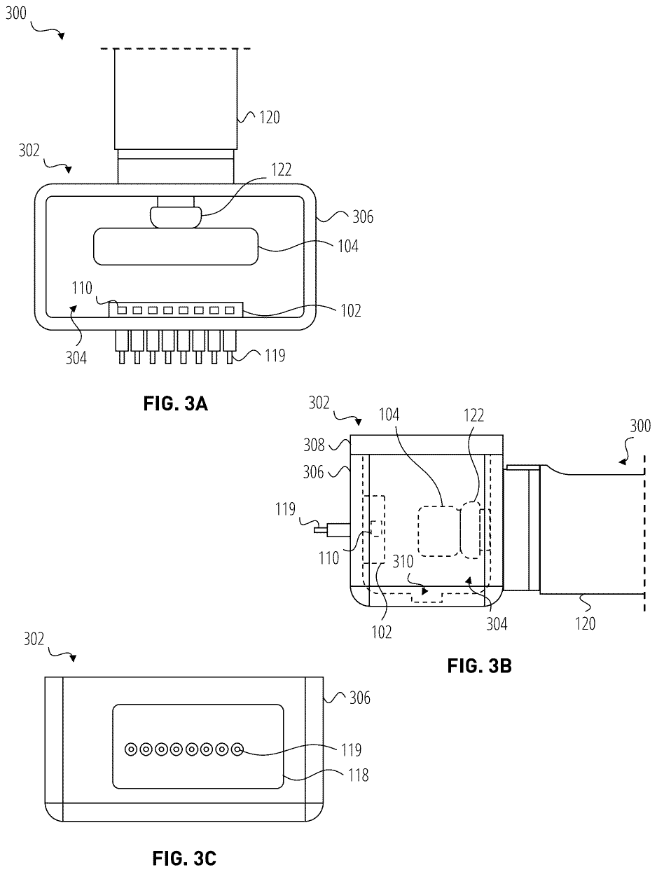

FIGS. 3A through 3C illustrate various views of an X-ray tube 300. FIG. 3A is a top-down view, FIG. 3B is a side view, and FIG. 3C is a front-to-back view. The X-ray tube 300 can be the same as or similar to the X-ray tube 100, except that an enclosure 302 of the X-ray tube 300 can be formed by billet machining, casting, or the like. Components of the X-ray tube 300 that are the same as or similar to components of the X-ray tube 300 are indicated with the same reference numbers as FIGS. 1A through 1C, and additional description of these components is omitted for simplicity.

The X-ray tube 300 can be used to generate X-rays. For example, the X-ray tube 300 can include a cathode assembly 102 and an anode assembly 104 positioned within an enclosure 302. The enclosure 302 can define an evacuated enclosure 304, which can maintain an ultra-high vacuum (UHV). A high voltage can be applied between the cathode assembly 102 and the anode assembly 104 such that electrons are emitted from individual cathodes 110 of the cathode assembly 102 towards target surfaces on the anode assembly 104. X-rays can be generated as the electrons impact the target surfaces on the anode assembly 104 and the X-rays can be emitted from the X-ray tube 300 through an X-ray window 310. The X-ray window 310 can be defined in the enclosure 302.

As discussed in reference to the X-ray tube 100, the enclosure 302 can be formed from aluminum-based materials. Using aluminum-based materials for the enclosure 302 can reduce the weight and cost of the X-ray tube 300. The enclosure 302 can include a body portion 306 and a lid 308. The body portion 306 and the lid 308 can each be formed from aluminum-based materials, such as aluminum, an aluminum alloy, or the like. For example, the body portion 306 and the lid 308 can be formed from any aluminum alloy including, but in no way limited to, a 5000 series, a 6000 series, or a 7000 series aluminum alloy. An aluminum concentration in each of the body portion 306 and the lid 308 may be at least about 1 weight percent (wt. %), at least about 3 wt. %, at least about 10 wt. %, at least about 90 wt. %, at least about 95 wt. %, at least about 97wt. %, or the like. Although the enclosure 302 is described as being formed from aluminum or an aluminum-based materials, in one or all examples, the enclosure 302 can be formed from other metals, such as steel (e.g., stainless steel), copper, titanium, tungsten, lead, combinations or alloys thereof, or the like.

The body portion 306 can have a rectangular shape in a top-down view (e.g., FIG. 3A) and a front-to-back view (e.g., FIG. 3C). The body portion 306 can have rounded corners. The body portion 306 can have a rectangular shape in a cross-sectional or side view (e.g., FIG. 3B), and an opening in the body portion 306 that houses components of the X-ray tube 300 can have a rectangular shape in the cross-sectional or side view. As illustrated in FIG. 3B, the body portion 306 can be U-shaped in a cross-sectional view. The body portion 306 can have a constant thickness, except in portions of the body portion 306 that are machined to house or define components of the X-ray tube 300 such as the cathode assembly 102, the anode assembly 104, the X-ray window 310, and the like. The lid 308 can have a shape that complements the top-down shape of the body portion 306. For example, the lid 308 can have a rectangular shape in a top-down view, a side view (e.g., illustrated in FIG. 3B), and a front-to-back view. In other words, the lid 308 can have the same outline or boundary as the body portion 306 in the top-down view. The body portion 306 and the lid 308 can have any suitable thickness, which can be dependent on the application for the X-ray tube 300.

The body portion 306 can be formed by billet machining, casting, other aluminum machining processes, or the like. The billet machining can define side surfaces and a bottom surface of the body portion 306. Forming the body portion 306 by billet machining, casting, or the like can be used to form the body portion 306 as a single or unitary component formed from a single, continuous material, which can reduce or eliminate welds, seams, or other interfaces in the enclosure 302. This can reduce assembly steps, assembly complexity, and leak points in the enclosure 302. Because aluminum is easy to machine, the shape of the body portion 306 can be machined from a single piece relatively quickly. This machining allows for an anode controlling surface (e.g., to which the anode assembly 104 is coupled), a cathode controlling surface (e.g., to which the cathode assembly 102 is coupled), and the respective window surface (e.g., the surface in which the X-ray window 310 is defined) to all have a tight CNC-controlled relationship. This allows for precise locating of the components of the X-ray tube 300 based on the machined surfaces. As such, forming the enclosure 302 from aluminum provides improved control of the spacing between the cathode assembly 102 and the anode assembly 104 and positions of the cathode assembly 102 and the anode assembly 104 relative to the X-ray window 310 and these characteristics can be achieved with better repeatability between enclosures 302 and X-ray tubes 300. This reduces device defects and improves throughput for the X-ray tubes 300.

An X-ray window 310 can be defined in the body portion 306 by machining processes (e.g., milling, turning, drilling, boring, reaming, plasma cutting, laser machining, water jet machining, or the like). In one or all examples, x-ray filtration requirements can differ from the x-ray filtration provided by the X-ray window 310 in the body portion 306. In such examples, additional window materials can be brazed, welded, bolted, or otherwise fastened to an inner or outer surface of the body portion 306. In one or all examples, a collimator can be brazed, welded, bolted, or otherwise fastened to an inner or outer surface of the body portion 306. The lid 308 can be formed from aluminum sheets or plates. The lid 308 can be welded to the body portion 306. The lid 308 can be mounted to top surfaces of the body portion 306 and/or the body portion 306 can be recessed and the lid 308 can be mounted to a recessed lip of the body portion 306. The enclosure 302 can have a limited number of welds, which reduces assembly steps, assembly complexity, and leak points in the enclosure 302. The enclosure 302 can include the body portion 306 and a single lid 308, which can reduce a part count, assembly steps, assembly time, and assembly complexity for the enclosure 302. Components of the X-ray tube 300 can be assembled into the body portion 306 through an opening that is later sealed by the lid 308. The X-ray tube 300 can be top-loaded.

The evacuated enclosure 304 of the X-ray tube 300 can be defined by the enclosure 302. For example, the body portion 306 can define four side surfaces of the evacuated enclosure 304, the body portion 306 can define a bottom surface of the evacuated enclosure 304, and the lid 308 can define a top surface of the evacuated enclosure 304. In other words, the lid 308 can define a single surface of the evacuated enclosure 304 and the body portion 306 can define five surfaces of the evacuated enclosure 304. The body portion 118 of the cathode assembly 102 can be coupled to the body portion 306 through an opening defined in a side surface of the body portion 306. The cable 120 and the connector 122 can be coupled to one another through an opening defined in a side surface of the body portion 306, and the anode assembly 104 can be coupled to the side surface of the body portion 306 through the connector 122.

By forming the body portion 306 and the lid 308 from aluminum, a weight of the enclosure 302 and the X-ray tube 300, material costs, and manufacturing time, steps, and costs, can be reduced. This can be particularly beneficial for multi-beam X-ray tubes, which have larger sizes and weights. Aluminum has less outgassing relative to stainless steel and other materials that can be used for X-ray tube enclosures, and the enclosure 302 can maintain an improved evacuated condition. Aluminum is a recyclable material and the components of the enclosure 302 can be recyclable. Further, as described above, the enclosure 302 can be formed from a limited number of components with a limited number of seams, welds, or interfaces, which further increases the recyclability of the enclosure 302. Further, various treatments can be performed on the X-ray tube 300, including surface treatments on surfaces of the enclosure 302, an out-gassing bake, and the like. Aluminum has a relatively high heat conductivity such that forming the X-ray window 310, which is subject to heating due to bombardment from X-rays, can improve heat dissipation by the X-ray window 310. Moreover, forming the X-ray window 310 from a material that is continuous with the body portion 306 further improves heat dissipation from the X-ray window 310 to the body portion 306.

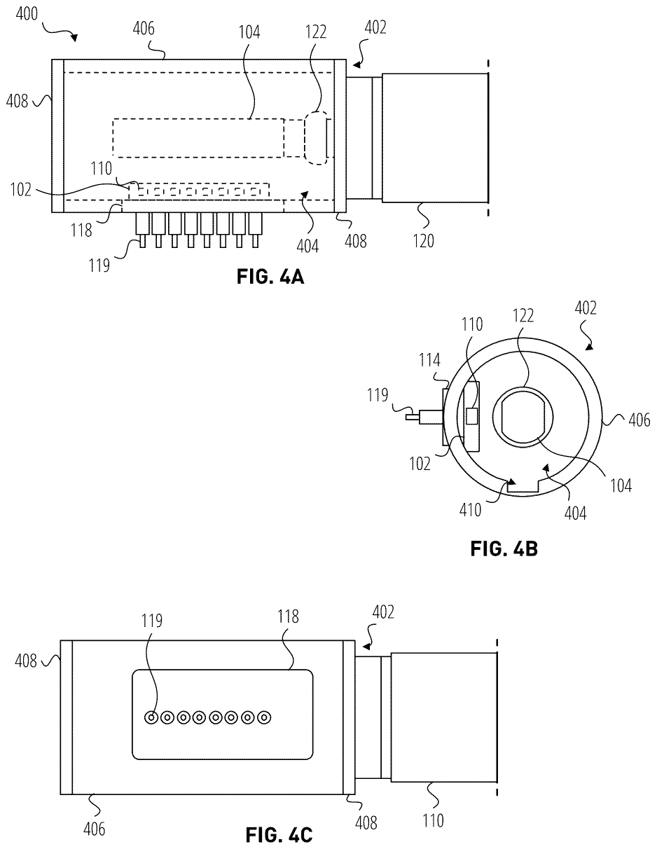

FIGS. 4A through 4C illustrate various views of an X-ray tube 400. FIG. 4A is a top-down view, FIG. 4B is a side view, and FIG. 4C is a front-to-back view. The X-ray tube 400 can be the same as or similar to the X-ray tube 100, except that an enclosure 402 of the X-ray tube 400 can have a circular or rounded shape in a cross-sectional or side view. Components of the X-ray tube 400 that are the same as or similar to components of the X-ray tube 100 are indicated with the same reference numbers as FIGS. 1A through 1C, and additional description of these components is omitted for simplicity.

The X-ray tube 400 can be used to generate X-rays. For example, the X-ray tube 400 can include a cathode assembly 102 and an anode assembly 104 positioned within an enclosure 402. The enclosure 402 can define an evacuated enclosure 404, which can maintain an ultra-high vacuum (UHV). A high voltage can be applied between the cathode assembly 102 and the anode assembly 104 such that electrons are emitted from individual cathodes 110 of the cathode assembly 102 towards target surfaces on the anode assembly 104. X-rays can be generated as the electrons impact the target surfaces on the anode assembly 104 and the X-rays can be emitted from the X-ray tube 400 through an X-ray window 410. The X-ray window 410 can be defined in the enclosure 402.

As discussed in reference to the X-ray tube 100, the enclosure 402 can be formed from aluminum-based materials. Using aluminum-based materials for the enclosure 402 can reduce the weight and cost of the X-ray tube 400. The enclosure 402 can include a body portion 406 and two end caps 408. The body portion 406 and the end caps 408 can each be formed from aluminum-based materials, such as aluminum, an aluminum alloy, or the like. For example, the body portion 406 and the end caps 408 can be formed from any aluminum alloy including, but in no way limited to, a 5000 series, a 6000 series, or a 7000 series aluminum alloy. An aluminum concentration in each of the body portion 406 and the end caps 408 may be at least about 1 weight percent (wt. %), at least about 3 wt. %, at least about 10 wt. %, at least about 90 wt. %, at least about 95 wt. %, at least about 97wt. %, or the like. Although the enclosure 402 is described as being formed from aluminum or an aluminum-based materials, in one or all examples, the enclosure 402 can be formed from other metals, such as steel (e.g., stainless steel), copper, titanium, tungsten, lead, combinations or alloys thereof, or the like.

The body portion 406 can have a rounded or circular shape in a cross-sectional or side view (e.g., FIG. 4B) and an opening in the body portion 406 that houses components of the X-ray tube 400 can have a rounded or circular shape in the cross-sectional or side view. The body portion 406 can have a rectangular shape in a top-down view (e.g., FIG. 4A) and a front-to-back view (e.g., FIG. 4C). The body portion 406 can have a constant thickness, except in portions of the body portion 406 that are machined to house or define components of the X-ray tube 400, such as the cathode assembly 102, the X-ray window 410, and the like. The end caps 408 can have shapes that complement the cross-sectional shape of the body portion 406. For example, the end caps 408 can have rounded or circular shapes in the side view illustrated in FIG. 4B. In other words, the end caps 408 can have the same outlines or boundaries as the body portion 406 in the side view. The body portion 406 and the end caps 408 can have any suitable thickness, which can be dependent on the application for the X-ray tube 400.

As illustrated in FIGS. 4A through 4C, the anode assembly 104 can be mounted to one of the end caps 408. In one or all examples, this can allow for multiple enclosures 402 to be coupled to one another in series, and a single cable 120 can supply power to multiple anode assemblies 104 with one anode assembly 104 disposed in each respective enclosure 402.

The evacuated enclosure 404 of the X-ray tube 400 can be defined by the enclosure 402. For example, the end caps 408 can define two side surfaces of the evacuated enclosure 404, the body portion 406 can define side surfaces of the evacuated enclosure 404, the body portion 406 can define a top surface of the evacuated enclosure 404, and the body portion 406 can define a bottom surface of the evacuated enclosure 404. In other words, the end caps 408 can define two surfaces of the evacuated enclosure 404 and the body portion 406 can define remaining surfaces of the evacuated enclosure 404. The body portion 118 of the cathode assembly 102 can be coupled to the body portion 406 through an opening defined in a side surface of the body portion 406. The cable 120 and the connector 122 can be coupled to one another through an opening defined in one of the end caps 408, and the anode assembly 104 can be coupled to the end cap 408 through the connector 122. Although the cable 120, the connector 122, and the anode assembly 104 are illustrated as being mounted to one of the end caps 408, in one or all examples, the cable 120, the connector 122, and the anode assembly 104 can be mounted to a wall of the body portion 406, similar to other examples described herein.

By forming the enclosure 402 with a rounded or circular shape, wasted space can be eliminated from the enclosure 402. This can reduce a volume of the evacuated enclosure 404 defined by the enclosure 402 and reduce electrical standoff, which can increase performance of the X-ray tube 400. Further, weight of the enclosure 402 can be reduced. Additional machining can be performed on the rounded enclosure 402 to provide flat surfaces for components of the X-ray tube 400 to be mounted to within the enclosure 402. For example, the X-ray window 410 can be defined in both an internal and an external surface of the body portion 406 such that the X-ray window 410 has a constant thickness in a direction in which X-rays pass through the X-ray window 410.

The body portion 406 can be formed by a near-net process, such as extrusion. As such, minimal additional manufacturing steps are performed on the body portion 406. This can, for example, reduce waste, manufacturing steps for forming the body portion 406, cost, and manufacturing time for the body portion 406. In one or all examples, the body portion 406 can be formed by billet machining, casting, other aluminum machining processes, or the like. Forming the body portion 406 by extrusion, billet machining, casting, or the like can be used to form the body portion 406 as a single or unitary component formed from a single, continuous material, which can reduce or eliminate welds, seams, or other interfaces in the enclosure 402. This can reduce assembly steps, assembly complexity, and leak points in the enclosure 402.

An X-ray window 410 can be defined in the body portion 406 by machining processes (e.g., milling, turning, drilling, boring, reaming, plasma cutting, laser machining, water jet machining, or the like). In one or all examples, x-ray filtration requirements can differ from the x-ray filtration provided by the X-ray window 410 in the body portion 406. In such examples, additional window materials can be brazed, welded, bolted, or otherwise fastened to an inner or outer surface of the body portion 406. In one or all examples, a collimator can be brazed, welded, bolted, or otherwise fastened to an inner or outer surface of the body portion 406. The end caps 408 can be formed from aluminum sheets or plates. Each of the end caps 408 can be welded to the body portion 406. The enclosure 402 can have a limited number of welds, which reduces assembly steps, assembly complexity, and leak points in the enclosure 402. The enclosure 402 can include the body portion 406 and the two end caps 408, which can reduce a part count, assembly steps, assembly time, and assembly complexity for the enclosure 402.

By forming the body portion 406 and the end caps 408 from aluminum, a weight of the enclosure 402 and the X-ray tube 400, material costs, and manufacturing time, steps, and costs, can be reduced. This can be particularly beneficial for multi-beam X-ray tubes, which have larger sizes and weights. Aluminum has less outgassing relative to stainless steel and other materials that can be used for X-ray tube enclosures, and the enclosure 402 can maintain an improved evacuated condition. Aluminum is a recyclable material and the components of the enclosure 402 can be recyclable. Further, as described above, the enclosure 402 can be formed from a limited number of components with a limited number of seams, welds, or interfaces, which further increases the recyclability of the enclosure 402.

Various portions of the enclosure 402 can be machined with tight tolerances in order to control the thickness of the X-ray window 410 and the spacing between components (e.g., between the cathode assembly 102 and the anode assembly 104). Aluminum is a material that is relatively easy to machine; thus, forming the enclosure 402 from aluminum can reduce machining time and difficulty for machining the enclosure 402 and allow for tighter tolerances to be achieved in the X-ray tube 400. This can help to machine the X-ray window 410 to a very accurate thickness and control a spacing between the cathode assembly 102 and the anode assembly 104. As such, forming the enclosure 402 from aluminum provides improved control of the spacing between the cathode assembly 102 and the anode assembly 104 and positions of the cathode assembly 102 and the anode assembly 104 relative to the X-ray window 410 and these characteristics can be achieved with better repeatability between enclosures 402 and X-ray tubes 400. This reduces device defects and improves throughput for the X-ray tubes 400. Further, various treatments can be performed on the X-ray tube 400, including surface treatments on surfaces of the enclosure 402, an out-gassing bake, and the like. Aluminum has a relatively high heat conductivity such that forming the X-ray window 410, which is subject to heating due to bombardment from X-rays, can improve heat dissipation by the X-ray window 410. Moreover, forming the X-ray window 410 from a material that is continuous with the body portion 406 further improves heat dissipation from the X-ray window 410 to the body portion 406.

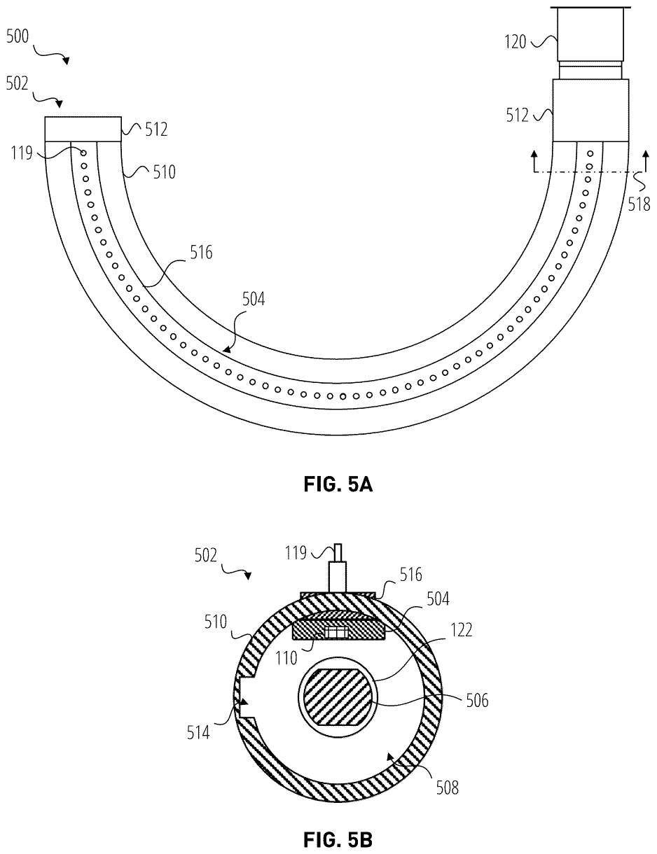

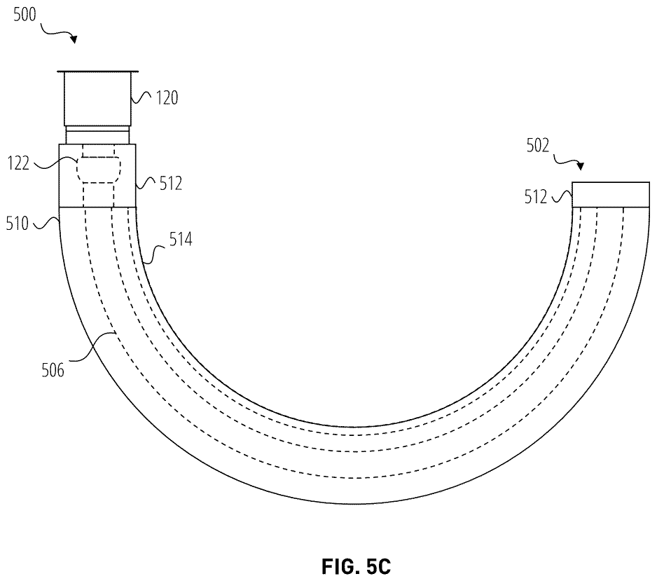

FIGS. 5A through 5C illustrate various views of an X-ray tube 500. FIG. 5A is a top-down view, FIG. 5B is a cross-sectional view along reference line 518 illustrated in FIG. 5A, and FIG. 5C is a top-up view. The X-ray tube 500 can be the same as or similar to the X-ray tube 400, except that the enclosure 502, a cathode assembly 504, and an anode assembly 506 of the X-ray tube 500 have a curved shape in the top-down view of FIG. 5A. Components of the X-ray tube 500 that are the same as or similar to components of the X-ray tubes 100, 400 are indicated with the same reference numbers as FIGS. 1A through 1C and 4A through 4C, and additional description of these components is omitted for simplicity. The curved shape of the X-ray tube 500 can be beneficial for computed tomography (CT) and other applications.

The X-ray tube 500 can be used to generate X-rays. For example, the X-ray tube 500 can include a cathode assembly 504 and an anode assembly 506 positioned within an enclosure 502. The enclosure 502 can define an evacuated enclosure 508, which can maintain an ultra-high vacuum (UHV). A high voltage can be applied between the cathode assembly 504 and the anode assembly 506 such that electrons are emitted from individual cathodes 110 of the cathode assembly 504 towards target surfaces on the anode assembly 506. X-rays can be generated as the electrons impact the target surfaces on the anode assembly 506 and the X-rays can be emitted from the X-ray tube 500 through an x-ray window 514. The x-ray window 514 can be defined in the enclosure 502.

As discussed in reference to the X-ray tube 100, the enclosure 502 can be formed from aluminum-based materials. Using aluminum-based materials for the enclosure 502 can reduce the weight and cost of the X-ray tube 500. The enclosure 502 can include a body portion 510 and two end caps 512. The body portion 510 and the end caps 512 can each be formed from aluminum-based materials, such as aluminum, an aluminum alloy, or the like. For example, the body portion 510 and the end caps 512 can be formed from any aluminum alloy including, but in no way limited to, a 5000 series, a 6000 series, or a 7000 series aluminum alloy. An aluminum concentration in each of the body portion 510 and the end caps 512 may be at least about 1 weight percent (wt. %), at least about 3 wt. %, at least about 10 wt. %, at least about 90 wt. %, at least about 95 wt. %, at least about 97 wt. %, or the like. Although the enclosure 502 is described as being formed from aluminum or an aluminum-based materials, in one or all examples, the enclosure 502 can be formed from other metals, such as steel (e.g., stainless steel), copper, titanium, tungsten, lead, combinations or alloys thereof, or the like.

The body portion 510 can have a rounded or circular shape in a cross-sectional view (e.g., FIG. 5B) and an opening in the body portion 510 that houses components of the X-ray tube 500 can have a rounded or circular shape in the cross-sectional view. The body portion 510 can have a curved shape (e.g., a U-shape) rectangular shape in a top-down view (e.g., FIG. 5A) and a bottom-up view (e.g., FIG. 5C). The body portion 510 can have a constant thickness, except in portions of the body portion 510 that are machined to house or define components of the X-ray tube 500, such as the cathode assembly 504, the X-ray window 514, and the like. The end caps 512 can have shapes that complement the cross-sectional shape of the body portion 510. For example, the end caps 512 can have rounded or circular shapes. In other words, the end caps 512 can have the same outlines or boundaries as the body portion 510. The body portion 510 and the end caps 512 can have any suitable thickness, which can be dependent on the application for the X-ray tube 500.

As illustrated in FIGS. 5A through 5C, the anode assembly 506 can be mounted to one of the end caps 512 through a connector 122. The anode assembly 506 can have a curved shape (e.g., a U-shape) that complements the shape of the body portion 510 such that the anode assembly 506 tracks the body portion 510 without contacting the body portion 510. The cathode assembly 504 can also have a curved shape (e.g., a U-shape) that complements the shape of the body portion 510.

The evacuated enclosure 508 of the X-ray tube 500 can be defined by the enclosure 502. For example, the end caps 512 can define two side surfaces of the evacuated enclosure 508, the body portion 510 can define side surfaces of the evacuated enclosure 508, the body portion 510 can define a top surface of the evacuated enclosure 508, and the body portion 510 can define a bottom surface of the evacuated enclosure 508. In other words, the end caps 512 can define two surfaces of the evacuated enclosure 508 and the body portion 510 can define remaining surfaces of the evacuated enclosure 508. A body portion 516 of the cathode assembly 504 can be coupled to the body portion 510 through an opening defined in a top surface of the body portion 510. The cable 120 and the connector 122 can be coupled to one another through an opening defined in one of the end caps 512, and the anode assembly 506 can be coupled to the end cap 512 through the connector 122.

By forming the enclosure 502 with a rounded or circular shape, wasted space can be eliminated from the enclosure 502. This can reduce a volume of the evacuated enclosure 508 defined by the enclosure 502 and reduce electrical standoff, which can increase performance of the X-ray tube 500. Further, weight of the enclosure 502 can be reduced. Additional machining can be performed on the rounded enclosure 502 in order to provide flat surfaces for components of the X-ray tube 500 to be mounted to within the enclosure 502. For example, the X-ray window 514 can be defined in both an internal and an external surface of the body portion 510 such that the X-ray window 514 has a constant thickness in a direction in which X-rays pass through the X-ray window 514.

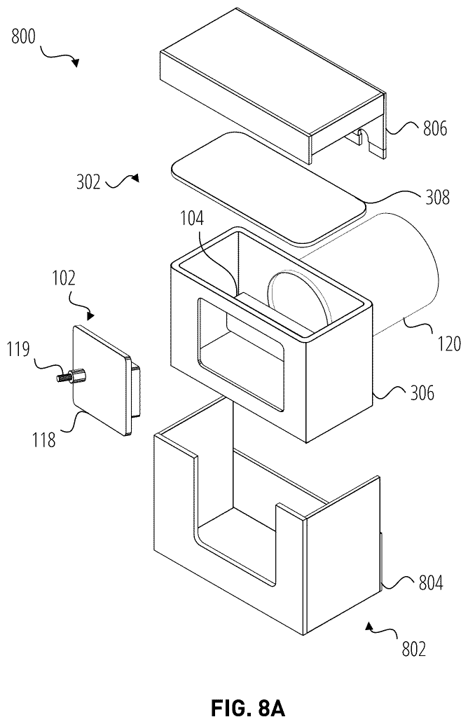

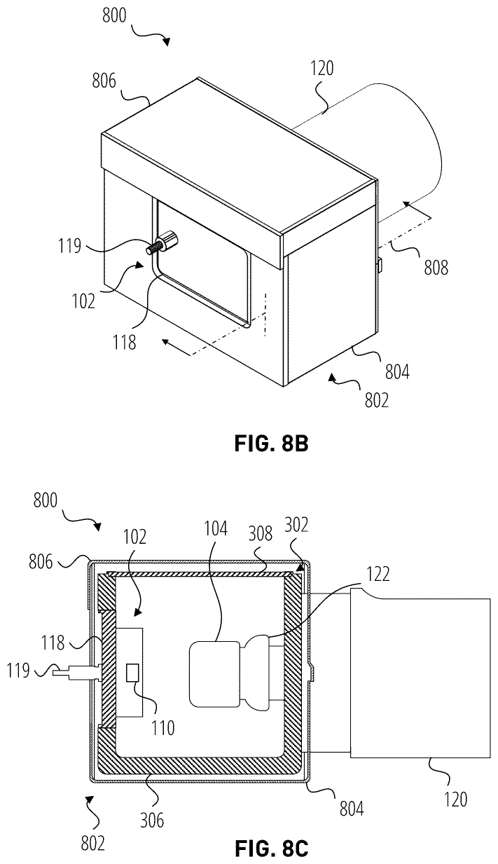

The body portion 510 can be formed by a near-net process, such as extrusion. As such, minimal additional manufacturing steps are performed on the body portion 510. This can, for example, reduce waste, manufacturing steps for forming the body portion 510, cost, and manufacturing time for the body portion 510. Forming the body portion 510 by extrusion or the like can be used to form the body portion 510 as a single or unitary component formed from a single, continuous material, which can reduce or eliminate welds, seams, or other interfaces in the enclosure 502. This can reduce assembly steps, assembly complexity, and leak points in the enclosure 502. The cross-section of the body portion 510 can be formed by extrusion and the curved shape of the body portion 510 (e.g., the U-shape) can be formed by bending, rolling, or otherwise deforming the body portion 510. Further, the round shape of the enclosure 502 can be easier to clad in lead or other shielding (e.g., as discussed below with respect to FIGS. 8A through 8C), which can allow for lead alternatives to be used to shield the X-ray tube 500. Lead alternatives can have reduced weight relative to lead, and this can reduce the weight of the X-ray tube 500.

In one or all examples, the curved shape of the body portion 510 (e.g., the U-shape) can be achieved by extruding the body portion 510 and placing the body portion 510 in the curved shape while the body portion 510 cools and solidified. The body portion 510 can be extruded or otherwise formed and can be heated and shaped into the curved shape. The body portion 510 can be extruded or otherwise formed, placed in a roller system, and cold rolled or hot rolled into the curved shape. Different radiuses for the curved shape of the body portion 510 can be achieved using different shaping methods to achieve the curved shape.

An X-ray window 514 can be defined in the body portion 510 by machining processes (e.g., milling, turning, drilling, boring, reaming, plasma cutting, laser machining, water jet machining, or the like). In one or all examples, x-ray filtration requirements can differ from the x-ray filtration provided by the X-ray window 514 in the body portion 510. In such examples, additional window materials can be brazed, welded, bolted, or otherwise fastened to an inner or outer surface of the body portion 510. In one or all examples, a collimator can be brazed, welded, bolted, or otherwise fastened to an inner or outer surface of the body portion 510. The end caps 512 can be formed from aluminum sheets or plates. Each of the end caps 512 can be welded to the body portion 510. The enclosure 502 can have a limited number of welds, which reduces assembly steps, assembly complexity, and leak points in the enclosure 502. The enclosure 502 can include the body portion 510 and the two end caps 512, which can reduce a part count, assembly steps, assembly time, and assembly complexity for the enclosure 502.

By forming the body portion 510 and the end caps 512 from aluminum, a weight of the enclosure 502 and the X-ray tube 500, material costs, and manufacturing time, steps, and costs, can be reduced. This can be particularly beneficial for multi-beam X-ray tubes, which have larger sizes and weights. Aluminum has less outgassing relative to stainless steel and other materials that can be used for X-ray tube enclosures, and the enclosure 502 can maintain an improved evacuated condition. Aluminum is a recyclable material and the components of the enclosure 502 can be recyclable. Further, as described above, the enclosure 502 can be formed from a limited number of components with a limited number of seams, welds, or interfaces, which further increases the recyclability of the enclosure 502.

Various portions of the enclosure 502 can be machined with tight tolerances in order to control the thickness of the X-ray window 514 and the spacing between components (e.g., between the cathode assembly 504 and the anode assembly 506). Aluminum is a material that is relatively easy to machine; thus, forming the enclosure 502 from aluminum can reduce machining time and difficulty for machining the enclosure 502 and allow for tighter tolerances to be achieved in the X-ray tube 500. This can help to machine the X-ray window 514 to a very accurate thickness and control a spacing between the cathode assembly 504 and the anode assembly 506. As such, forming the enclosure 502 from aluminum provides improved control of the spacing between the cathode assembly 504 and the anode assembly 506 and positions of the cathode assembly 504 and the anode assembly 506 relative to the X-ray window 514 and these characteristics can be achieved with better repeatability between enclosures 502 and X-ray tubes 500. This reduces device defects and improves throughput for the X-ray tubes 500. Further, various treatments can be performed on the X-ray tube 500, including surface treatments on surfaces of the enclosure 502, an out-gassing bake, and the like. Aluminum has a relatively high heat conductivity such that forming the X-ray window 510, which is subject to heating due to bombardment from X-rays, can improve heat dissipation by the X-ray window 510. Moreover, forming the X-ray window 510 from a material that is continuous with the body portion 510 further improves heat dissipation from the X-ray window 510 to the body portion 510.

The cathode assembly 504 can include a body portion 516 to which the cathodes 110 are coupled. The body portion 516 can be formed from one or more metal materials and can be welded to the body portion 510. For example, the body portion 516 can include stainless steel and aluminum, which can be bonded to one another by any suitable direct metal-to-metal bonding technique, such as diffusion bonding, explosion bonding, ultrasonic welding, friction welding, or the like. The aluminum of the body portion 516 can be bonded to the body portion 510 by welding. As illustrated in FIG. 5A, the body portion 516 can have a rounded shape that complements the shape of the body portion 510 (e.g., a U-shape). Power can be supplied to portions of the cathodes 110 outside the evacuated enclosure 508 defined by the enclosure 502. The weld between the body portion 516 and the body portion 510 can achieve a reliable hermetic seal. Further, surfaces of the body portion 516 can at least partially define the evacuated enclosure 508 and the surfaces of the body portion 516 that define the evacuated enclosure 508 can be formed from aluminum. This helps to prevent any outgassing from the body portion 516 into the evacuated enclosure 508. The body portion 516 of the cathode assembly 504 can be coupled to the body portion 510 through an opening defined in a top surface of the body portion 510.

The curved X-ray tube 500 is described in the context of an X-ray tube with a circular cross-sectional shape. However, any of the cross-sectional shapes described herein can be bent, curved, or rounded to form X-ray tubes with curved shapes. Moreover, different methods can be used to form tubes with curved shapes. For example, the X-ray tube 300 is described as being formed by billet machining or the like. In one or all examples, the X-ray tube 300 can be formed with a curved shape, rather than a rectangular shape, through billet machining, any this can be used to form a curved X-ray tube with any desired radius.

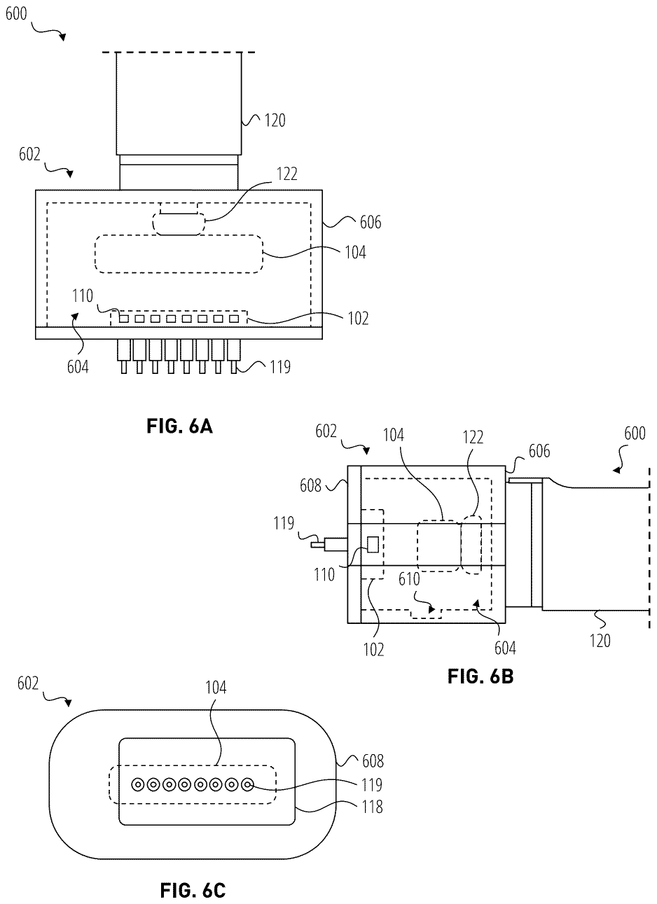

FIGS. 6A through 6C illustrate various views of an X-ray tube 600. FIG. 6A is a top-down view, FIG. 6B is a side view, and FIG. 6C is a front-to-back view. The X-ray tube 600 can be the same as or similar to the X-ray tube 100, except that an enclosure 602 of the X-ray tube 600 can be formed by billet machining, casting, or the like. The X-ray tube 600 can be the same as or similar to the X-ray tube 300, except that the X-ray tube 600 is front-loaded instead of top loaded. Components of the X-ray tube 600 that are the same as or similar to components of the X-ray tube 600 are indicated with the same reference numbers as FIGS. 1A through 1C, and additional description of these components is omitted for simplicity.

The X-ray tube 600 can be used to generate X-rays. For example, the X-ray tube 600 can include a cathode assembly 102 and an anode assembly 104 positioned within an enclosure 602. The enclosure 602 can define an evacuated enclosure 604, which can maintain an ultra-high vacuum (UHV). A high voltage can be applied between the cathode assembly 102 and the anode assembly 104 such that electrons are emitted from individual cathodes 110 of the cathode assembly 102 towards target surfaces on the anode assembly 104. X-rays can be generated as the electrons impact the target surfaces on the anode assembly 104 and the X-rays can be emitted from the X-ray tube 600 through an x-ray window 610. The x-ray window 610 can be defined in the enclosure 602.

As discussed in reference to the X-ray tube 100, the enclosure 602 can be formed from aluminum-based materials. Using aluminum-based materials for the enclosure 602 can reduce the weight and cost of the X-ray tube 600. The enclosure 602 can include a body portion 606 and a lid 608. The body portion 606 and the lid 608 can each be formed from aluminum-based materials, such as aluminum, an aluminum alloy, or the like. For example, the body portion 606 and the lid 608 can be formed from any aluminum alloy including, but in no way limited to, a 5000 series, a 6000 series, or a 7000 series aluminum alloy. An aluminum concentration in each of the body portion 606 and the lid 608 may be at least about 1 weight percent (wt. %), at least about 3 wt. %, at least about 10 wt. %, at least about 90 wt. %, at least about 95 wt. %, at least about 97wt. %, or the like. Although the enclosure 602 is described as being formed from aluminum or an aluminum-based materials, in one or all examples, the enclosure 602 can be formed from other metals, such as steel (e.g., stainless steel), copper, titanium, tungsten, lead, combinations or alloys thereof, or the like.

The body portion 606 can have a rectangular shape in a top-down view (e.g., FIG. 6A) and a front-to-back view (e.g., FIG. 6C). The body portion 606 can have rounded corners. The body portion 606 can have a rectangular shape in a cross-sectional or side view (e.g., FIG. 6B), and an opening in the body portion 606 that houses components of the X-ray tube 600 can have a rectangular shape in the cross-sectional or side view. As illustrated in FIG. 6B, the body portion 606 can be U-shaped in a cross-sectional view. The body portion 606 can have a constant thickness, except in portions of the body portion 606 that are machined to house or define components of the X-ray tube 600 such as the anode assembly 104, the x-ray window 610, and the like. The lid 608 can have a shape that complements the front-to-back shape of the body portion 606. For example, the lid 608 can have a rectangular shape in a front-to-back view, a side view (e.g., illustrated in FIG. 6B), and a top-down view. In other words, the lid 608 can have the same outline or boundary as the body portion 606 in the front-to-back view. The body portion 606 and the lid 608 can have any suitable thickness, which can be dependent on the application for the X-ray tube 600.

As illustrated in FIGS. 6A through 6C, the cathode assembly 102 can be mounted to the lid 608. The cathode assembly 102 can include a body portion 118 to which the cathodes 110 are coupled. The body portion 118 can be formed from one or more metal materials and can be welded to the lid 608. For example, the body portion 118 can include stainless steel and aluminum, which can be bonded to one another by any suitable direct metal-to-metal bonding technique, such as diffusion bonding, explosion bonding, ultrasonic welding, friction welding, or the like. The aluminum of the body portion 118 can be bonded to the lid 608 by welding. In one or all examples, the lid 608 can be used as the body portion 118 and a separate body portion can be omitted.

The body portion 606 can be formed by billet machining, casting, other aluminum machining processes, or the like. Forming the body portion 606 by extrusion, billet machining, casting, or the like can be used to form the body portion 606 as a single or unitary component formed from a single, continuous material, which can reduce or eliminate welds, seams, or other interfaces in the enclosure 602. This can reduce assembly steps, assembly complexity, and leak points in the enclosure 602. Because aluminum is easy to machine, the shape of the body portion 606 can be machined from a single piece relatively quickly. This machining allows for an anode controlling surface (e.g., to which the anode assembly 104 is coupled), a cathode controlling surface (e.g., to which the lid 608 is coupled), and the respective window surface (e.g., the surface in which the x-ray window 610 is defined) to all have a tight CNC-controlled relationship. This allows for precise locating of the components of the X-ray tube 600 based on the machined surfaces. As such, forming the enclosure 602 from aluminum provides improved control of the spacing between the cathode assembly 102 and the anode assembly 104 and positions of the cathode assembly 102 and the anode assembly 104 relative to the x-ray window 610 and these characteristics can be achieved with better repeatability between enclosures 602 and X-ray tubes 600. This reduces device defects and improves throughput for the X-ray tubes 600.

An x-ray window 610 can be defined in the body portion 606 by machining processes (e.g., milling, turning, drilling, boring, reaming, plasma cutting, laser machining, water jet machining, or the like). In one or all examples, x-ray filtration requirements can differ from the x-ray filtration provided by the X-ray window 610 in the body portion 606. In such examples, additional window materials can be brazed, welded, bolted, or otherwise fastened to an inner or outer surface of the body portion 606. In one or all examples, a collimator can be brazed, welded, bolted, or otherwise fastened to an inner or outer surface of the body portion 606. Although the x-ray window 610 is illustrated as being formed in an interior surface of the body portion 606, in one or all examples, the x-ray window 610 can be defined in an exterior surface of the body portion 606. The lid 608 can be formed from aluminum sheets or plates. The lid 608 can be welded to the body portion 606. The lid 608 can be mounted to top surfaces of the body portion 606 and/or the body portion 606 can be recessed and the lid 608 can be mounted to a recessed lip of the body portion 606. The enclosure 602 can have a limited number of welds, which reduces assembly steps, assembly complexity, and leak points in the enclosure 602. The enclosure 602 can include the body portion 606 and a single lid 608, which can reduce a part count, assembly steps, assembly time, and assembly complexity for the enclosure 602. Components of the X-ray tube 600 can be assembled into the body portion 606 through an opening that is later sealed by the lid 608. The X-ray tube 600 can be front-loaded.

The evacuated enclosure 604 of the X-ray tube 600 can be defined by the enclosure 602. For example, the lid 608 can define a side surface of the evacuated enclosure 604, the body portion 606 can define three side surfaces of the evacuated enclosure 604, the body portion 606 can define a bottom surface of the evacuated enclosure 604, and the body portion 606 can define a top surface of the evacuated enclosure 604. In other words, the lid 608 can define a single surface of the evacuated enclosure 604 and the body portion 606 can define five surfaces of the evacuated enclosure 604. The body portion 118 of the cathode assembly 102 can be coupled to the lid 608 through an opening defined in the lid 608. The cable 120 and the connector 122 can be coupled to one another through an opening defined in a side surface of the body portion 606, and the anode assembly 104 can be coupled to the side surface of the body portion 606 through the connector 122.

By forming the body portion 606 and the lid 608 from aluminum, a weight of the enclosure 602 and the X-ray tube 600, material costs, and manufacturing time, steps, and costs, can be reduced. This can be particularly beneficial for multi-beam X-ray tubes, which have larger sizes and weights. Aluminum has less outgassing relative to stainless steel and other materials that can be used for X-ray tube enclosures, and the enclosure 602 can maintain an improved evacuated condition. Aluminum is a recyclable material and the components of the enclosure 602 can be recyclable. Further, as described above, the enclosure 602 can be formed from a limited number of components with a limited number of seams, welds, or interfaces, which further increases the recyclability of the enclosure 602. Further, various treatments can be performed on the X-ray tube 600, including surface treatments on surfaces of the enclosure 602, an out-gassing bake, and the like. Aluminum has a relatively high heat conductivity such that forming the X-ray window 610, which is subject to heating due to bombardment from X-rays, can improve heat dissipation by the X-ray window 610. Moreover, forming the X-ray window 610 from a material that is continuous with the body portion 606 further improves heat dissipation from the X-ray window 610 to the body portion 606.

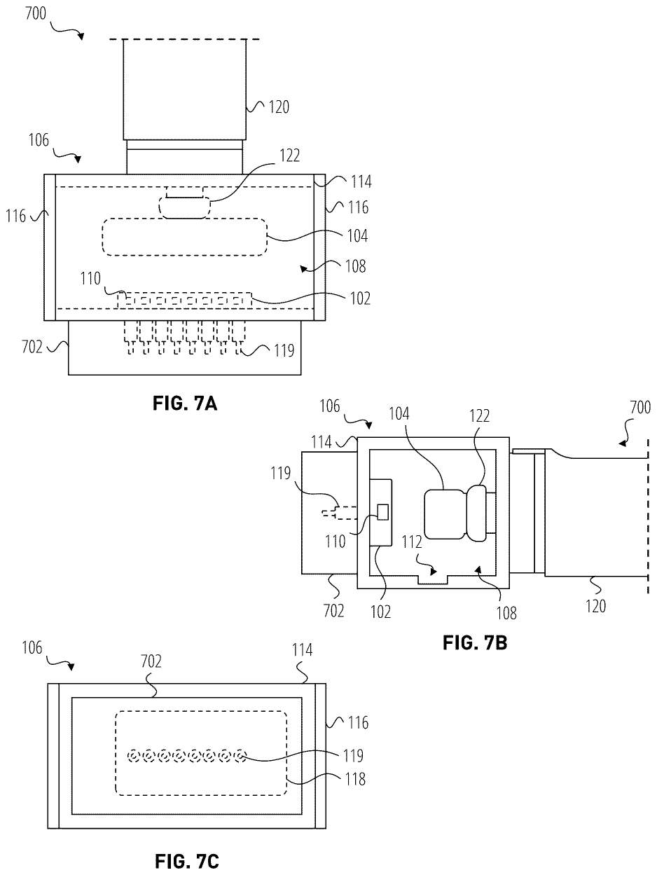

FIGS. 7A through 7C illustrate various views of an X-ray tube 700. FIG. 7A is a top-down view, FIG. 7B is a side view, and FIG. 7C is a front-to-back view. The X-ray tube 700 can be the same as or similar to the X-ray tube 100, except that the X-ray tube 700 further includes electronics 702. Components of the X-ray tube 700 that are the same as or similar to components of the X-ray tube 100 are indicated with the same reference numbers as FIGS. 1A through 1C, and additional description of these components is omitted for simplicity.

As illustrated in FIGS. 7A through 7C, the electronics 702 can be mounted directly to a side of the enclosure 106. The electronics 702 can be mounted to a side surface of the enclosure 106, such as a side surface on which the cathode assembly 102 is positioned. This can provide a number of advantages. For example, the electronics 702 do not take up additional vertical space (e.g., in the vertical direction of FIG. 7A), and the X-ray tube 700 can be positioned closer to a patient or object to be analyzed. The electronics 702 can be positioned close to the cathode assembly 102 such that a distance between circuits in the electronics 702 and the cathodes 110 is short. This provides arc protection, dissipates arcs into the circuits of the electronics 702, and provides less charge build up. Heat can be generated in the electronics 702. Because aluminum is a good heat spreader and the electronics 702 are positioned adjacent to the aluminum enclosure 106, heat can be dissipated from the electronics 702 to the enclosure 106. Because of the reduced weight of the aluminum enclosure 106, it is possible to position the electronics 702 on the X-ray tube 700, which may not be practical with a heavier X-ray tube. The electronics 702 can be mounted to the enclosure 106 by any suitable means, such as brazing, fasteners, clips, glues, threads, welding, soldering, or the like.

FIGS. 8A through 8C illustrate various views of an X-ray tube 800. FIG. 8A is an exploded view, FIG. 8B is a perspective view, and FIG. 8C is a cross-sectional view along reference line 808 illustrated in FIG. 8B. The X-ray tube 800 can be the same as or similar to the X-ray tube 300, except that the X-ray tube 800 further includes a shield 802 (also referred to as an enclosure, a lead-lined enclosure, a box, a lead-lined box, or the like). Components of the X-ray tube 800 that are the same as or similar to components of the X-ray tube 100, 300 are indicated with the same reference numbers as FIGS. 1A through 1C and 3A through 3C, and additional description of these components is omitted for simplicity.

As illustrated in FIGS. 8A through 8C, the shield 802 can include an enclosure body 804 and an enclosure lid 806. The shield 802 can be provided to block X-rays generated by the X-ray tube 800 from being emitted from the X-ray tube 800 in undesirable directions. In other words, the shield 802 can prevent radiation leakage from the X-ray tube 800 above acceptable limits from locations other than an X-ray window defined in the enclosure 302. In one or all examples, the shield 802 can be formed from or include lead or lead-based materials (e.g., foamed tungsten lead or the like). In one or all examples, an X-ray blocking material, such as lead, can be applied to the enclosure 302 as a coating or the like. The enclosure body 804 and the enclosure lid 806 can be mounted around the lead coating to protect the lead coating. The enclosure body 804 and the enclosure lid 806 can be formed from bent sheet metal. In one or all examples, a lead coating can be applied to inner surfaces of the enclosure body 804 and the enclosure lid 806. In one or all examples, the enclosure body 804 and the enclosure lid 806 can include a lead material, which can be clad with another material. By enclosing lead of the shield 802 with another material, people handling the X-ray tube 800 can be protected from exposure to lead. Openings can be provided in the various components of the shield 802, such as for the cathode assembly 102, an X-ray window (not separately illustrated in FIGS. 8A through 8C), the cable 120, and the like.

The foregoing description, for purposes of explanation, used specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An X-ray tube comprising:
a cathode;
an anode; and
an enclosure at least partially surrounding the cathode and the anode, the enclosure comprising an aluminum alloy at least partially defining an evacuated enclosure of the X-ray tube.

2. The X-ray tube of claim 1, wherein the cathode is one of a plurality of cold cathode emitters disposed at least partially in the enclosure.

3. The X-ray tube of claim 1, wherein the aluminum alloy of the enclosure defines an X-ray window.

4. The X-ray tube of claim 1, wherein the aluminum alloy of the enclosure comprises a single continuous material defining a plurality of side surfaces of the evacuated enclosure.

5. The X-ray tube of claim 1, wherein:
the single continuous material of the aluminum alloy of the enclosure defines at least five side surfaces of the evacuated enclosure; and
the enclosure further comprises an aluminum alloy lid welded to the single continuous material.

6. The X-ray tube of claim 1, wherein:
the single continuous material of the aluminum alloy of the enclosure defines at least four side surfaces of the evacuated enclosure; and
the enclosure further comprises two aluminum alloy end caps welded to the single continuous material.

7. The X-ray tube of claim 1, wherein the enclosure comprises an octagonal cross-sectional shape.

8. The X-ray tube of claim 1, wherein the enclosure comprises a rounded cross-sectional shape.

9. The X-ray tube of claim 1, wherein the enclosure and an X-ray window defined in the enclosure have curved shapes in a cross-sectional view.

10. A method of manufacturing an enclosure for an X-ray tube, the method comprising:
forming an enclosure body from an aluminum alloy;
machining an X-ray window in the enclosure;
welding a wall to the enclosure body to form an enclosure; and
evacuating the enclosure at least partially defined by the enclosure body and the wall.

11. The method of claim 10, wherein the enclosure body is formed by billet machining.

12. The method of claim 11, the billet machining defines side surfaces and a bottom surface of the enclosure body that define at least five surfaces of the enclosure.

13. The method of claim 10, wherein the enclosure body comprises an extrusion.

14. The method of claim 13, wherein the extrusion defines side surfaces of the enclosure body that define at least four surfaces of the enclosure.

15. The method of claim 10, further comprising anodizing an inner surface of the enclosure body.

16. The method of claim 10, further comprising:
mounting a cathode assembly to the enclosure body;
mounting an anode assembly to the enclosure body; and
performing a bake-out process on the enclosure at a temperature of 250° C. or less after mounting the cathode assembly and the anode assembly.

17. An X-ray source, comprising an enclosure, the enclosure including a plurality of surfaces defining an evacuated enclosure, a material defining the plurality of surfaces formed from aluminum or an aluminum alloy comprising at least 1 weight percent aluminum.

18. The X-ray source of claim 17, further comprising a plurality of cold cathode emitters coupled to the enclosure, wherein the X-ray source is configured to produce a plurality of X-ray beams.

19. The X-ray source of claim 17, wherein the material defining the plurality of surfaces comprises a 5000 series aluminum alloy or a 6000 series aluminum alloy.

20. The X-ray source of claim 17, wherein the material comprises a single continuous material defining at least four surfaces of the plurality of surfaces.
